(19) United States
(12) Patent Application Publication
(10) Pub. No.: US 2026/0351000 A1
(43) Pub. Date: Nov. 5, 2026

(54) SELECTIVE MASKING OF SURVEILLANCE VIDEO

(71) Applicant: HANWHA VISION CO., LTD., Seongnam-si (KR)

(72) Inventors: Daebong KIM, Seongnam-si (KR); Hwayoung PACK, Seongnam-si (KR); Woohyun KIM, Seongnam-si (KR); Changho SONG, Seongnam-si (KR)

(21) Appl. No.: 19/713,380

(22) Filed: Jun. 18, 2026

Related U.S. Application Data
(63) Continuation of application No. PCT/KR2024/020937, filed on Dec. 23, 2024.

(30) Foreign Application Priority Data
Dec. 22, 2023 (KR) 10-2023-0189238

(51) Int. Cl. G06V 20/52; G06V 10/26; G06V 10/82; G06V 20/40; H04N 7/18

(52) U.S. Cl. CPC G06V 20/52; G06V 10/26; G06V 20/44; H04N 7/183; G06V 10/82

(57) ABSTRACT

The present disclosure relates to a selective masking apparatus and method for surveillance video. The selective masking method for surveillance video may include: receiving, from a surveillance camera, surveillance video obtained by capturing a surveillance area; when a first object is recognized by analyzing the surveillance video, applying masking to the first object in a first state; when a predetermined object is detected from the first object, changing masking applied to the first object from the first state to a second state; and, when an event associated with the predetermined object is detected in the surveillance video, removing the masking from the first object masked in the second state.

### CROSS-REFERENCE TO RELATED APPLICATIONS

This application is a continuation of International Application No. PCT/KR2024/020937, filed Dec. 23, 2024, which claims the benefit of priority under 35 U.S.C. § 119(a) to Korean Patent Application No. 10-2023-0189238, filed Dec. 22, 2023, in the Korean Intellectual Property Office, the entire disclosures of which are incorporated herein by reference.

### TECHNICAL FIELD

The present disclosure relates to a technology for masking surveillance video obtained by a surveillance camera.

### BACKGROUND

In a surveillance system using surveillance video captured by a surveillance camera, it is essential to protect personal information related to the privacy of a person included in video data obtained by the surveillance camera. Based on computer vision technology, a personal information area, such as a facial area, may be detected in surveillance video, and the detected personal information area may be privacy-masked, for example, by mosaic processing or blurring, thereby protecting portions through which personal information may otherwise be exposed.

However, when a crime occurs in surveillance video or when a person identified as, for example, a criminal appears in the surveillance video, there is a need for a selective privacy masking technology in which privacy masking is not applied to a person related to the crime or the identified person.

The contents described above are provided merely to aid understanding of background technology related to the technical ideas of the present disclosure, and therefore, should not be construed as an admission that the contents correspond to prior art known to those skilled in the art in the technical field of the present disclosure.

### SUMMARY

The present disclosure has been made to solve the above-described problems. An embodiment of the present disclosure is directed to selectively applying masking by determining, in real time, an area to which privacy masking is to be applied and an area to which privacy masking is not to be applied in surveillance video.

In addition, an embodiment of the present disclosure is directed to removing masking from a corresponding area when it is determined that a suspected criminal situation or a dangerous situation has occurred while privacy masking is being applied to surveillance video.

In addition, an embodiment of the present disclosure is directed to solving a problem caused by applying privacy masking to a person related to a crime or a dangerous situation, by automatically changing a privacy masking state of, or not applying privacy masking to, a corresponding object or an object related to a corresponding situation when a dangerous object or a dangerous situation is detected while privacy masking is being applied to surveillance video.

The problems to be solved by the present disclosure are not limited to the above-mentioned problems, and other unmentioned problems will be clearly understood by those skilled in the art from the following description.

The present disclosure provides a selective masking method for surveillance video. The method may include: receiving, from a surveillance camera, surveillance video obtained by capturing a surveillance area; when a first object is recognized by analyzing the surveillance video, applying masking to the first object in a first state; when a predetermined object is detected from (e.g., within) the first object, changing masking applied to the first object from the first state to a second state; and when an event associated with the predetermined object is detected in the surveillance video, removing the masking from the first object masked in the second state.

The selective masking method for surveillance video and other embodiments may include the following features.

According to an embodiment, removing the masking from the first object masked in the second state when the event associated with the predetermined object is detected in the surveillance video may include: generating an alarm notifying that a masking removal target event has occurred when the event associated with the predetermined object is detected in the surveillance video; and, when approval by (e.g., of) a user is received in response to the alarm, removing the masking from the first object masked in the second state.

According to an embodiment, the selective masking method for surveillance video may further include generating an alarm notifying that a masking removal event has occurred when the masking applied to the first object is removed in the surveillance video.

According to an embodiment, removing the masking from the first object masked in the second state when the event associated with the predetermined object is detected in the surveillance video may include: when the predetermined object is a blunt weapon or a sharp or edged weapon, removing the masking from the first object masked in the second state when it is detected that the first object swings the predetermined object or stabs another object with the predetermined object in the surveillance video; when the predetermined object is a firearm, removing the masking from the first object masked in the second state when a screaming sound or a gunfire sound is detected in the surveillance video; and, when the predetermined object is an object located near the first object, removing the masking from the first object masked in the second state when it is detected that the first object performs a harmful action against another object using the predetermined object in the surveillance video.

Meanwhile, the present disclosure provides a selective masking apparatus for surveillance video. The apparatus may include: a communication interface configured to receive surveillance video obtained by a surveillance camera capturing a surveillance area; object recognition circuitry configured to analyze the surveillance video based on artificial intelligence and recognize an object in the surveillance video; situation determination circuitry configured to analyze the surveillance video based on artificial intelligence, determine an action of a first object in the surveillance video, and detect or classify a sound occurring in the surveillance video; and masking circuitry configured to apply masking to an object recognized by the object recognition circuitry according to a masking criterion. The masking circuitry may be configured to: when the object recognition circuitry recognizes the first object in the surveillance video, apply masking to the first object in a first state; when the object recognition circuitry detects a predetermined object from (e.g., within) the first object, change masking applied to the first object from the first state to a second state; and, when the situation determination circuitry detects an event associated with the predetermined object in the surveillance video, remove the masking from the first object masked in the second state.

The selective masking apparatus for surveillance video and other embodiments may include the following features.

According to an embodiment, when the situation determination circuitry detects the event associated with the predetermined object in the surveillance video, the masking circuitry may generate an alarm notifying that a masking removal target event has occurred, and, when approval by (e.g., of) a user is received in response to the alarm, may remove the masking from the first object masked in the second state.

According to an embodiment, when the object recognition circuitry recognizes a second object in the surveillance video, the masking circuitry may apply masking in the first state to at least a portion of the second object, and, when the situation determination circuitry determines that the first object from which the masking has been removed has performed an action associated with the second object, may remove the masking from the at least a portion masked in the first state.

According to an embodiment, the masking circuitry may be configured to: when the object recognition circuitry detects a blunt weapon or a sharp or edged weapon among the predetermined objects in the surveillance video, and the situation determination circuitry detects, in the surveillance video, that the first object swings the predetermined object or stabs another object with the predetermined object, remove the masking from the first object masked in the second state; when the object recognition circuitry detects a firearm among the predetermined objects in the surveillance video, and the situation determination circuitry detects a screaming sound or a gunfire sound in the surveillance video, remove the masking from the first object masked in the second state; and, when the object recognition circuitry detects, among the predetermined objects, an object located near the first object, and the situation determination circuitry detects, in the surveillance video, that the first object performs a harmful action against another object using the predetermined object, remove the masking from the first object masked in the second state.

In another aspect, the present disclosure provides a selective masking method for surveillance video. The method may include: receiving, from a surveillance camera, surveillance video obtained by capturing a surveillance area; when a plurality of first objects are recognized by analyzing the surveillance video, applying masking in a first state to portions of the plurality of first objects and outputting the surveillance video; when a predetermined object is detected from (e.g., within) the plurality of first objects in the surveillance video, changing masking applied to a first object, among the plurality of first objects, from which the predetermined object is detected, from the first state to a second state and outputting the surveillance video; and, when an event associated with the predetermined object is detected by analyzing an action of the first object masked in the second state in the surveillance video, removing the masking from the first object masked in the second state and outputting the surveillance video.

In addition, the selective masking method and apparatus for surveillance video, and other embodiments, may include the following features.

According to an embodiment, the event associated with the predetermined object may be an action or a sound associated with the predetermined object.

According to an embodiment, the predetermined object may include a firearm, a sharp or edged weapon, and a blunt weapon.

According to an embodiment, the sound associated with the predetermined object may include a gunfire sound or a screaming sound, and the action associated with the predetermined object may include an action of holding or firing a firearm, an action of stabbing with or swinging a sharp or edged weapon, and an action of swinging a blunt weapon.

According to an embodiment, the selective masking method for surveillance video may further include: when a second object is recognized in the surveillance video, applying masking in the first state to at least a portion of the second object; and, when it is determined that the first object from which the masking has been removed has entered or boarded the second object, removing the masking from the at least a portion masked in the first state.

According to embodiments disclosed in the present disclosure, masking can be selectively applied by determining, in real time, an area to which privacy masking is to be applied and an area to which privacy masking is not to be applied in surveillance video.

In addition, according to embodiments disclosed in the present disclosure, when it is determined that a suspected criminal situation or a dangerous situation has occurred while privacy masking is being applied to surveillance video, masking can be removed from a corresponding area.

In addition, according to embodiments disclosed in the present disclosure, when a dangerous object or a dangerous situation is detected while privacy masking is being applied to surveillance video, a privacy masking state of a corresponding object or an object related to the corresponding situation can be automatically changed, or privacy masking can be automatically not applied thereto, thereby solving a problem caused by applying privacy masking to a person related to a crime or a dangerous situation.

Meanwhile, the effects that can be obtained from the present disclosure are not limited to the effects mentioned above, and other effects not mentioned will be clearly understood by those skilled in the art in the technical field to which the present disclosure pertains from the following description.

### BRIEF DESCRIPTION OF THE DRAWINGS

The following drawings attached to this specification illustrate preferred embodiments of the present disclosure, and serve to further understand the technical spirit of the present disclosure together with the detailed description for carrying out the disclosure, so the present disclosure should not be construed as being limited only to the matters described in such drawings.

FIG. 1 illustrates a configuration of a selective masking system for surveillance video according to an embodiment.

FIG. 2 is a block diagram schematically illustrating an internal configuration of a surveillance camera included in the selective masking system for surveillance video.

FIG. 3 is a diagram illustrating a configuration of a video management device operating as a selective masking apparatus for surveillance video according to an embodiment.

FIG. 4 is a block diagram of an AI processing unit of FIG. 3.

FIG. 5 is a diagram illustrating a selective masking method for surveillance video according to an embodiment.

FIGS. 6A and 6B illustrate an example in which privacy masking is applied when a person object is recognized in surveillance video.

FIGS. 7A and 7B illustrate an example in which a masking state is changed when a predetermined object associated with a recognized person object is detected.

FIGS. 8A and 8B illustrate an example in which a masking state is changed when an event occurs in surveillance video.

FIGS. 9A and 9B illustrate a masking application method when a person object from which masking has been removed enters or boards a vehicle object.

FIG. 10 is a diagram illustrating, as functional blocks, a configuration of a selective masking apparatus for surveillance video according to an embodiment.

### DETAILED DESCRIPTION

The technology disclosed in the present disclosure may be applied to selective masking technology for surveillance video. However, the technology disclosed in the present disclosure is not limited thereto, and may also be applied to all apparatuses and methods to which the technical spirit of the technology may be applied.

The technical terms used in the present specification are used only to describe specific embodiments, and are not intended to limit the technical idea of the technology disclosed in the present specification. In addition, the technical terms used in the present specification should be interpreted as having meanings generally understood by those skilled in the art in the field to which the technology disclosed in the present specification belongs, unless otherwise specifically defined in the present specification, and should not be interpreted as having an unduly broad meaning or an unduly narrow meaning. In addition, when a technical term used in the present specification is an erroneous technical term that does not accurately represent the technical idea of the technology disclosed in the present specification, the technical term should be understood as being replaced with a technical term that can be correctly understood by those skilled in the art. In addition, general terms used in the present specification should be interpreted according to dictionary definitions or the context, and should not be interpreted as having an unduly narrow meaning.

Terms including ordinal numbers, such as “first” and “second,” used in the present specification may be used to describe various components, but the components are not limited by such terms. The terms are used only for the purpose of distinguishing one component from another component. For example, without departing from the scope of the present disclosure, a first component may be referred to as a second component, and similarly, a second component may also be referred to as a first component.

Hereinafter, embodiments disclosed in the present specification will be described in detail with reference to the accompanying drawings. In the drawings, the same or similar components are denoted by the same reference numerals, and redundant descriptions thereof will be omitted.

In addition, in describing the technology disclosed in the present specification, when it is determined that a detailed description of related known technologies may obscure the gist of the technology disclosed in the present specification, the detailed description thereof will be omitted. In addition, it should be noted that the accompanying drawings are provided only for facilitating understanding of the technical idea of the technology disclosed in the present specification, and the technical idea should not be construed as being limited by the accompanying drawings.

An image according to an embodiment of the present disclosure includes both a still image and a moving image unless otherwise specified.

Throughout the specification, a device or a terminal includes a communication terminal or a communication device capable of wired or wireless communication with a server or another device. The device or terminal may have various forms such as a mobile phone, a smartphone, a smart pad, a laptop computer, a desktop computer, a smart TV, a wearable device and the like. The wearable device may be implemented in various forms, such as a watch-type terminal, an eyeglass-type terminal, a head-mounted display (HMD), and the like. In addition, the terminal is not limited to these forms and may be implemented as various electronic devices.

Hereinafter, embodiments will be described in detail with reference to the accompanying drawings.

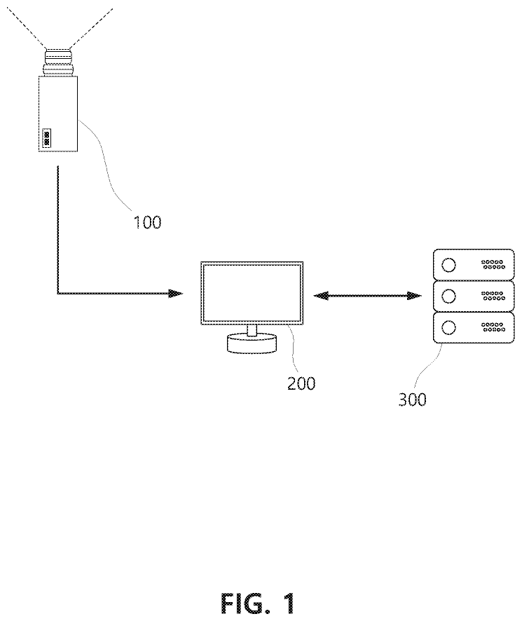

FIG. 1 illustrates a configuration of a selective masking system for surveillance video according to an embodiment.

Referring to FIG. 1, a selective masking system 1000 for surveillance video may include a surveillance camera 100, a video management device 200, and a video storage 300.

The surveillance camera 100 captures a surveillance area to obtain surveillance feed (e.g., surveillance video, audiovisual feed, surveillance audiovisual feed, visual feed, surveillance visual feed, etc.) of the surveillance area. The surveillance camera 100 may be connected to the video management device 200 through a network, and may transmit video data of the obtained surveillance video to the video management device 200 through the network.

The video management device 200 may include a video security solution, such as a digital video recorder (DVR), a central management system (CMS), a network video recorder (NVR), or a video management system (VMS), or a display device. The video management device 200 may receive, through the network, video data obtained by the surveillance camera 100 and output the video data to an operator through a display, and may also transmit the received video data to the video storage 300. All or at least a portion of the configuration of the video management device 200 may operate as a selective masking apparatus for surveillance video according to an embodiment.

Accordingly, the video management device 200 may selectively apply masking, according to a predetermined criterion, to an object detected based on the surveillance video received from the surveillance camera 100. Data of the surveillance video to which selective masking has been applied may be transmitted to the video storage 300 and temporarily or permanently stored therein. Video data stored in the video storage 300 may be encrypted and protected for security.

The video storage 300 may include at least one type of storage medium selected from a flash memory type, a hard disk type, a solid state disk (SSD) type, a silicon disk drive (SDD) type, a multimedia card micro type, a card-type memory, such as an SD memory or an XD memory, random access memory (RAM), static random access memory (SRAM), read-only memory (ROM), electrically erasable programmable read-only memory (EEPROM), programmable read-only memory (PROM), magnetic memory, a magnetic disk, and an optical disk, and may store video data received from the video management device 200. The video data may include video to which privacy masking, that is, de-identification, has been applied to an object requiring privacy protection, such as a person or a vehicle.

Meanwhile, all or at least a portion of the configuration of the surveillance camera 100 may also operate as the selective masking apparatus for surveillance video according to an embodiment. That is, the surveillance camera 100 itself, as an edge device, may selectively apply masking, according to a predetermined criterion, to an object detected in video captured by the surveillance camera 100. Hereinafter, the video management device 200 will be described as an example of the selective masking apparatus according to an embodiment, but the related configuration and functions may be equally applied to the surveillance camera 100.

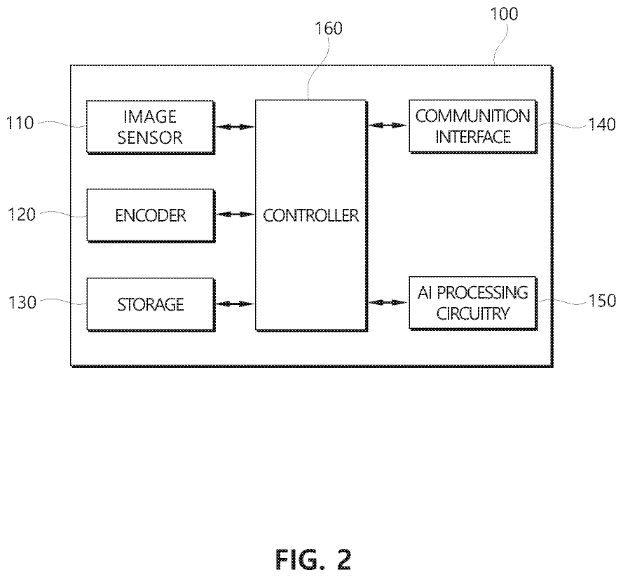

FIG. 2 is a block diagram schematically illustrating an internal configuration of a surveillance camera included in the selective masking system for surveillance video.

Referring to FIG. 2, the surveillance camera 100 may include an image sensor 110, an encoder 120, a storage 130, a communication interface 140, AI processing circuitry 150, and controller 160.

The image sensor 110 performs a function of capturing a surveillance area to obtain surveillance video, and may be implemented as, for example, a charge-coupled device (CCD) sensor, a complementary metal-oxide-semiconductor (CMOS) sensor, or the like.

The encoder 120 performs an operation of encoding the surveillance video obtained through the image sensor 110 into a digital signal, and may comply with, for example, H.264, H.265, MPEG (Moving Picture Experts Group), M-JPEG (Motion Joint Photographic Experts Group), or the like.

The storage 130 may store a program for operation of the controller 160, and may temporarily store input/output data and generated data. In addition, the storage 130 may store video data, audio data, still images, metadata, and the like. The metadata may include object detection information, such as movement, sound, and intrusion into a designated area, object identification information, such as a person, a vehicle, a face, a hat, and clothing, and detected position information, such as coordinates and size, of an object captured in the surveillance area.

The still image may be generated together with the metadata and stored in the storage 130, and may be generated by capturing image information of a specific analysis area from among video analysis information. For example, the still image may be implemented as a JPEG image file. For example, the still image may be generated by cropping a specific area of video data determined to include an identifiable object from among video data of the surveillance area detected during a specific period in a specific area, and may be transmitted in real time together with the metadata.

The communication interface 140 may transmit the video data, audio data, still image, and/or metadata to the video management device 200 of FIG. 1. According to an embodiment, the communication interface 140 may transmit the video data, audio data, still image, and/or metadata to the video management device in real time. The communication interface 140 may perform at least one communication function selected from wired/wireless local area network (LAN), Wi-Fi, ZigBee, Bluetooth, and near field communication (NFC).

The AI processing circuitry 150 is configured to process video based on artificial intelligence. According to an embodiment of the present disclosure, the AI processing circuitry 150 performs object detection, object identification, and object tracking algorithms based on learned deep learning in video obtained through the surveillance camera 100 of the selective masking system 1000 for surveillance video based on artificial intelligence video analysis. The AI processing circuitry 150 may be implemented as one module together with the controller 160 that controls the overall system, or may be implemented as an independent module. The AI processing circuitry 150 may also be implemented as a separate module or device separated from the surveillance camera 100.

The controller 160 may control all operations related to functions of the surveillance camera 100 and all other components, including the image sensor 110, the encoder 120, the storage 130, the communication interface 140, and the AI processing circuitry 150.

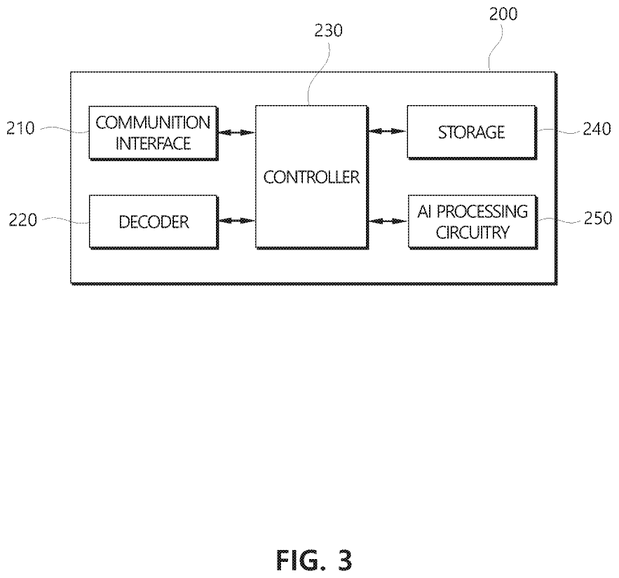

FIG. 3 is a diagram illustrating a configuration of a video management device operating as a selective masking apparatus for surveillance video according to an embodiment.

Referring to FIG. 3, the video management device 200 may include a communication interface 210, a decoder 220, controller 230, a storage 240, and AI processing circuitry 250. The illustrated components are not essential, and the video management device 200 may be implemented with more or fewer components. These components may be implemented as hardware, software, or a combination of hardware and software.

The communication interface 210 may communicate with the communication interface 140 of the surveillance camera of FIG. 2 through a network, and may receive video data, audio data, still images, and/or metadata from the surveillance camera in real time. The communication interface 210 may perform at least one communication function among networks described below.

The network disclosed herein may be, for example, a wireless network, a wired network, a public network such as the Internet, a private network, a global system for mobile communication (GSM) network for a mobile communication network, a general packet radio service (GPRS) network, a local area network (LAN), a wide area network (WAN), a metropolitan area network (MAN), a cellular network, a public switched telephone network (PSTN), a personal area network, Bluetooth, Wi-Fi Direct, near field communication, ultra-wideband, a combination thereof, or any other network, but is not limited thereto.

The decoder 220 may decode video data, audio data, still images, and/or metadata that are transmitted from the surveillance camera in an encoded state and received by the video management device 200.

The storage 240 may store a program for operation of the controller 230, and may temporarily store input/output data and generated data. In addition, the storage 240 may store video data, audio data, still images, metadata, and the like. The metadata may include object information detected in surveillance feed (e.g., surveillance video, audiovisual feed, surveillance audiovisual feed, visual feed, surveillance visual feed, etc.), such as movement, sound, intrusion into a designated area, a dangerous article, and a dangerous action, object identification information, such as a person, a vehicle, a face, a hat, clothing, a vehicle license plate, a sharp or edged weapon, and a weapon, and detected position information, such as coordinates and size.

The controller 230 may control all operations related to functions of the video management device 200 and all other components, including the communication interface 210, the decoder 220, the storage 240, and the AI processing circuitry 250. In particular, the controller 230 may cooperate with the AI processing circuitry 250 to detect an object in surveillance video received from the surveillance camera, and may apply or remove masking with respect to objects according to a predetermined criterion.

The AI processing circuitry 250 is configured to process video based on artificial intelligence. According to an embodiment of the present disclosure, the AI processing circuitry 250 performs, based on learned deep learning, object detection, object identification, object action determination, situation determination, detection of sound generated from an object, situation determination related to the detected sound, and object tracking algorithms in video obtained through the surveillance camera 100 of the selective masking system 1000 for surveillance video. The AI processing circuitry 250 may be implemented as one module together with the controller 230 that controls the overall system, or may be implemented as an independent module. The AI processing circuitry 250 may also be implemented as a separate module or device separated from the video management device 200.

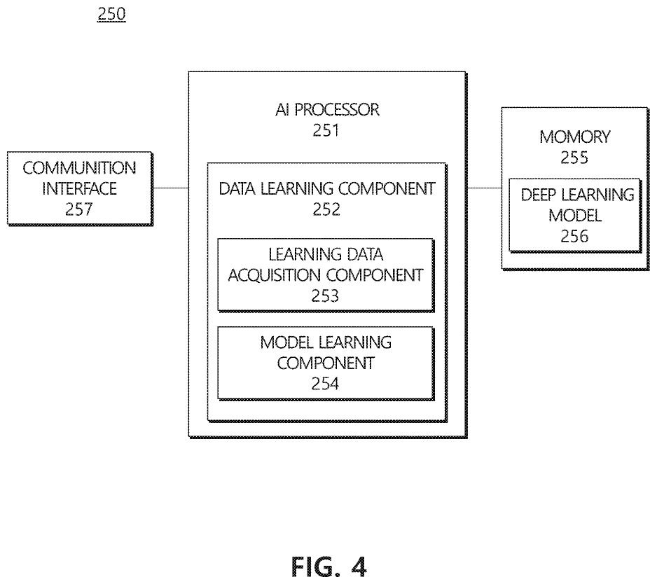

The AI processing circuitry 250 may functionally include object recognition circuitry configured to recognize an object in surveillance video and situation determination circuitry configured to determine a situation occurring in the surveillance video, and may operate as the object recognition circuitry and the situation determination circuitry. The object recognition circuitry may include an object recognition model capable of recognizing or tracking an object in video based on deep learning. The situation determination circuitry may include a situation determination model capable of determining a situation related to an object recognized in video, or detecting sound occurring in the feed (e.g., surveillance feed, audiovisual feed, surveillance audiovisual feed, visual feed, surveillance visual feed, video, surveillance video, etc.) and recognizing a situation related to the sound. The object recognition model and the situation determination model may be included in a deep learning model 256 described below with reference to FIG. 4.

FIG. 4 is a block diagram of the AI processing circuitry of FIG. 3.

The AI processing circuitry 250 may include an electronic device including an AI module capable of performing AI processing, or a server including the AI module. In addition, the AI processing circuitry 250 may be included as at least a portion of the video management device 200 illustrated in FIG. 3, and may be provided to perform at least a portion of AI processing operations performed by the video management device 200.

AI processing performed by the AI processing circuitry 250 may include all operations related to control by the controller 230 illustrated in FIG. 3, and all operations for video recognition through artificial intelligence learning. For example, the AI processing circuitry 250 may process video data of a surveillance area obtained by the image sensor of the surveillance camera using an AI model based on a YOLO model, thereby performing an operation of recognizing that a vehicle or a person appears in the surveillance video. The AI processing circuitry 250 may be included as a component of the controller 230 of FIG. 3.

The AI processing circuitry 250 may include an AI processor 251, a memory 255, and/or a communication interface 257.

The AI processing circuitry 250 may be a computing device capable of training a neural network, and may be implemented as various electronic devices, such as a server, a desktop PC, a notebook PC, and a tablet PC, or may be implemented as a single chip.

The AI processor 251 may train a neural network using a program stored in the memory 255. In particular, the AI processor 251 may train a neural network for recognizing device-related data. Here, the neural network for recognizing device-related data may be designed to simulate a human brain structure on a computer, and may include a plurality of network nodes having weights that simulate neurons of a human neural network. The plurality of network nodes may transmit and receive data according to respective connection relationships so as to simulate synaptic activity of neurons that transmit and receive signals through synapses. Here, the neural network may include a deep learning model developed from a neural network model. In the deep learning model, the plurality of network nodes may be located in different layers and may transmit and receive data according to convolutional connection relationships. Examples of the neural network model may include various deep learning techniques, such as deep neural networks (DNNs), convolutional neural networks (CNNs), recurrent neural networks (RNNs), restricted Boltzmann machines (RBMs), deep belief networks (DBNs), and deep Q-networks, and may be applied to fields such as computer vision (CV), speech recognition, natural language processing, and speech/signal processing.

A processor that performs the above-described functions may be a general-purpose processor, such as a central processing unit (CPU), or may be an AI-dedicated processor for artificial intelligence learning, such as a graphics processing unit (GPU).

The memory 255 may store various programs and data necessary for operation of the AI processing circuitry 250. The memory 255 may be implemented as nonvolatile memory, volatile memory, flash memory, a hard disk drive (HDD), a solid state drive (SSD), or the like. The memory 255 may be accessed by the AI processor 251, and data may be read, written, modified, deleted, updated, or the like by the AI processor 251. In addition, the memory 255 may store a neural network model, for example, a deep learning model 256, generated through a learning algorithm for data classification/recognition according to an embodiment of the present disclosure.

Meanwhile, the AI processor 251 may include a data learning component 252 configured to train a neural network for data classification/recognition. The data learning component 252 may learn criteria regarding which training data is to be used to determine data classification/recognition, and how data is to be classified and recognized using the training data. The data learning component 252 may obtain training data to be used for learning and apply the obtained training data to the deep learning model, thereby training the deep learning model.

The data learning component 252 may be manufactured in the form of at least one hardware chip and mounted in the AI processing circuitry 250. For example, the data learning component 252 may be manufactured in the form of a dedicated hardware chip for artificial intelligence (AI), or may be manufactured as a part of a general-purpose processor (CPU) or a graphics processor (GPU) and mounted in the AI processing circuitry 250. In addition, the data learning component 252 may be implemented as a software module. When implemented as a software module, or a program module including instructions, the software module may be stored in a non-transitory computer-readable medium. In this case, at least one software module may be provided by an operating system or by an application.

The data learning component 252 may include a training data acquisition component 253 and a model learning component 254.

The training data acquisition component 253 may obtain training data required for a neural network model for classifying and recognizing data. For example, the training data acquisition component 253 may obtain, as training data, training data and/or sample data regarding objects, actions, and sounds in surveillance feed (e.g., surveillance video, audiovisual feed, surveillance audiovisual feed, visual feed, surveillance visual feed, etc.) to be input to the neural network model.

The model learning component 254 may train the neural network model using the obtained training data so that the neural network model has criteria for determining how to classify predetermined data. In this case, the model learning component 254 may train the neural network model through supervised learning using at least a portion of the training data as determination criteria. Alternatively, the model learning component 254 may train the neural network model through unsupervised learning in which the neural network model learns by itself using the training data without supervision and discovers determination criteria. In addition, the model learning component 254 may train the neural network model through reinforcement learning using feedback as to whether a result of situation determination based on learning is correct. In addition, the model learning component 254 may train the neural network model using a learning algorithm including error back-propagation or gradient descent.

When the neural network model is trained, the model learning component 254 may store the trained neural network model in the memory. The model learning component 254 may also store the trained neural network model in a memory of a server connected to the AI processing circuitry 250 through a wired or wireless network.

The data learning component 252 may further include a training data preprocessing component, not illustrated, and a training data selection component, not illustrated, in order to improve an analysis result of a recognition model or reduce resources or time required to generate the recognition model.

The training data preprocessing component may preprocess obtained data so that the obtained data may be used for learning for situation determination. For example, the training data preprocessing component may process the obtained data into a predetermined format so that the model learning component 254 may use the obtained training data for learning for recognizing objects, actions, and/or sounds in surveillance feed (e.g., surveillance video, audiovisual feed, surveillance audiovisual feed, visual feed, surveillance visual feed, etc.).

In addition, the training data selection component may select data required for learning from among training data obtained by the training data acquisition component 253 or training data preprocessed by the preprocessing component. The selected training data may be provided to the model learning component 254. For example, the training data selection component may select only data included in a specific field as training data by recognizing the specific field from among a data set collected through a network.

In addition, the data learning component 252 may further include a model evaluation component, not illustrated, in order to improve an analysis result of the neural network model.

The model evaluation component may input evaluation data to the neural network model and, when an analysis result output from the evaluation data does not satisfy a predetermined criterion, may cause the model learning component 254 to perform learning again. In this case, the evaluation data may be predefined data for evaluating the recognition model. For example, when the number or ratio of pieces of evaluation data for which an analysis result of the trained recognition model is incorrect exceeds a preset threshold among analysis results of the trained recognition model for the evaluation data, the model evaluation component may evaluate that the predetermined criterion is not satisfied.

Although the AI processing circuitry 250 illustrated in FIG. 4 has been described as being functionally divided into the AI processor 251, the memory 255, the communication interface 257, and the like, the above-described components may be integrated into one module and referred to as an AI module, an artificial intelligence-based video analysis module, an artificial intelligence-based object recognition module, or an artificial intelligence-based situation recognition module.

Hereinafter, a selective masking method for surveillance video according to an embodiment will be described with reference to FIGS. 3 to 5.

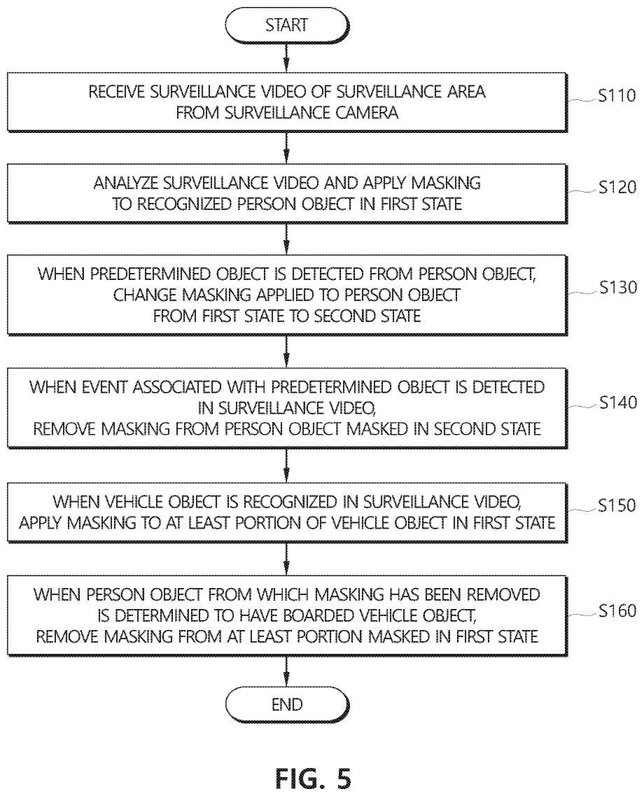

FIG. 5 is a diagram illustrating a selective masking method for surveillance video according to an embodiment.

Referring to FIGS. 3 to 5, first, the video management device 200 receives surveillance video obtained by capturing a surveillance area from the surveillance camera (S110). The video management device 200 receives video data of the surveillance video from the communication interface 140 of the surveillance camera through the communication interface 210, and the controller 230 transmits the received video data of the surveillance video to the AI processing circuitry 250 to analyze the surveillance video based on artificial intelligence.

When an object recognition model of the AI processing circuitry 250 analyzes the input surveillance video and recognizes a person object to which privacy masking is to be applied in the surveillance video, the controller 230 applies privacy masking to a predetermined area including the recognized person object so that the object cannot be identified (S120). Here, a masking-applied portion for the recognized person object may be set to a predetermined area including the entire person object according to a preset value, or may be set only to a facial partial area sufficient to make the person unidentifiable.

In this case, when the object recognition model of the AI processing circuitry 250 further detects a predetermined object associated with the person object to which privacy masking has been applied, the controller 230 changes and applies the masking applied to the person object to a state different from the privacy masking state (S130). For example, the predetermined object may be a condition for determining a violent situation or a criminal situation, and may include a firearm, a sharp or edged weapon, such as a knife, or a dangerous object located near (e.g., within a threshold distance from) the person object, such as a chair or a club. In this case, when the AI processing circuitry 250 detects the predetermined object, such as a firearm or a sharp or edged weapon, from (e.g., within) the recognized person object, the controller 230 may change the masking state by adjusting a color, intensity, shape, range, size, or the like of the masking applied to the person object, so that an operator or law enforcement personnel may readily recognize the person object holding the firearm or the sharp or edged weapon. According to an embodiment, video of the object whose masking state has been changed may be separately displayed in the form of a pop-up or a picture-in-picture (PIP) within an entire operator viewer screen so that the operator can easily observe the object.

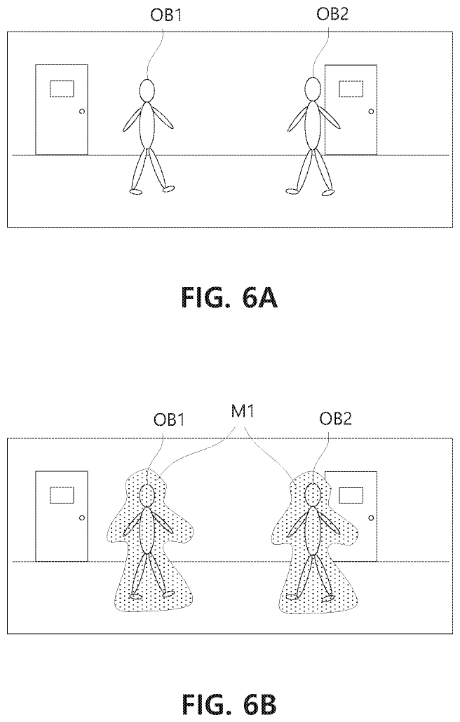

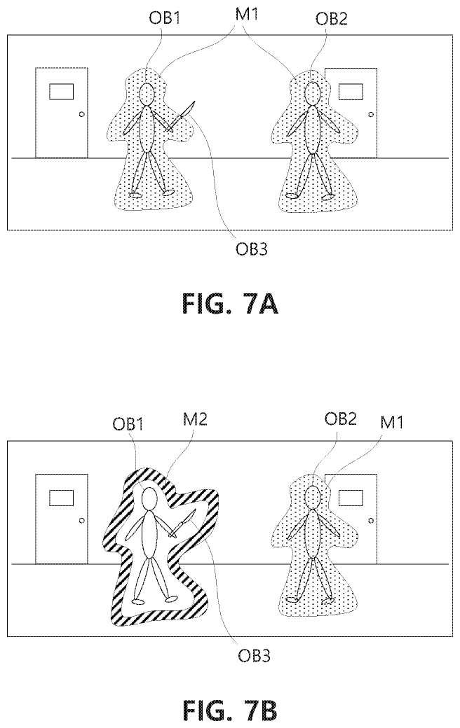

FIGS. 6A and 6B illustrate an example in which privacy masking is applied when person objects are recognized in surveillance video, and FIGS. 7A and 7B illustrate an example in which a masking state is changed when a predetermined object associated with a recognized person object is detected.

FIG. 6A illustrates a state in which the AI processing circuitry 250 analyzes input surveillance video and recognizes person objects OB1 and OB2 to which privacy masking is to be applied in the surveillance video. FIG. 6B illustrates a state in which the controller 230 applies privacy masking M1 to a predetermined area including the person objects OB1 and OB2 recognized by the AI processing circuitry 250, so that the objects cannot be identified.

FIG. 7A illustrates a state in which the AI processing circuitry 250 detects a predetermined object OB3, such as a firearm or a sharp or edged weapon, from a specific object OB1 among the person objects to which privacy masking is to be applied. In this case, as illustrated in FIG. 7B, the controller 230 changes and applies the masking state of the privacy masking M1 already applied to the person object OB1 holding the predetermined object OB3 from a first state M1 to a second state M2, so that an operator or law enforcement personnel may readily recognize the person object OB1. In this case, masking of the person object OB2 for which no predetermined object is detected maintains the previous state M1.

Referring to FIGS. 3 to 7, when the situation determination model of the AI processing circuitry 250 detects an event associated with the predetermined object OB3 in the surveillance video, the controller 230 removes the masking from the person object whose masking state has been changed, that is, OB1 of FIG. 7, so that an operator or law enforcement personnel may readily identify the person object (S140). Here, the event associated with the predetermined object OB3 may be occurrence of a sound or an action associated with the predetermined object OB3, and may be an action or a sound determined to indicate that a criminal act has been committed by the person object holding the predetermined object OB3, that is, OB1 of FIG. 7. The situation determination model of the AI processing circuitry 250 is trained to detect an action of a person object in the surveillance video and a sound occurring in the surveillance video, and to determine a situation related to a crime or violence. The sound associated with the predetermined object may be, for example, a gunfire sound or a screaming sound of a person. The action associated with the predetermined object may be an action of holding or firing a firearm, an action of stabbing with or swinging a sharp or edged weapon, or an action of swinging a blunt weapon.

Specifically, when the predetermined object is a blunt weapon or a sharp or edged weapon, the masking applied to the person object masked in the changed state M2, that is, OB1 of FIG. 7, may be removed when it is detected in the surveillance video that the person object swings the predetermined object or stabs another person object with the predetermined object. In addition, when the predetermined object is a firearm, the masking applied to the person object masked in the changed state M2, that is, OB1 of FIG. 7, may be removed when a screaming sound of a person or a gunfire sound is detected in the surveillance video, or when an action of aiming, brandishing, or firing the firearm is detected in the surveillance video. In addition, when the predetermined object is an object located near (e.g., within a threshold distance from) the person object, the masking applied to the person object masked in the changed state M2, that is, OB1 of FIG. 7, may be removed when it is detected in the surveillance video that the person object performs a harmful action against another person object, for example, by holding and swinging an object located near (e.g., within a threshold distance from) the person object, such as a chair or a blunt weapon.

According to an embodiment, a process of removing the masking from the second state M2 of the person object OB1 from which the predetermined object OB3 is detected may be performed as follows. First, when the controller 230 detects an event associated with the predetermined object OB3 in the surveillance video, the controller 230 notifies an operator of an alarm indicating that a masking removal target event has occurred with respect to the person object OB1 masked in the second state M2. When approval by (e.g., of) the operator is received in response to the alarm, the controller 230 may remove the masking from the person object masked in the second state M2. Here, the event associated with the predetermined object OB3 may mean occurrence of a sound or an action associated with the predetermined object OB3. The controller 230 may remove masking from an area preset by the operator according to an option selected by the operator, such as a face or an upper body of a masked object.

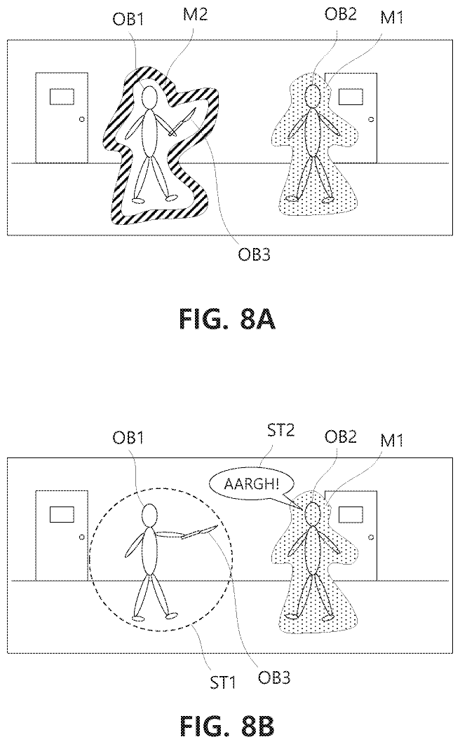

FIGS. 8A and 8B illustrate an example in which masking is removed when an event occurs in surveillance video.

FIG. 8A illustrates a state in which the changed masking M2 is applied, as in FIG. 7B, to the person object OB1 holding the predetermined object OB3 so that an operator or law enforcement personnel may readily recognize the person object OB1. As illustrated in FIG. 8B, when the situation determination model of the AI processing circuitry 250 detects an action ST1 and a sound ST2 determined to indicate that an event corresponding to a masking removal condition, such as a criminal act, has occurred, the controller 230 notifies the operator by an alarm that the event corresponding to the masking removal condition has occurred, and removes the masking already applied to the person object OB1 holding the predetermined object OB3 according to approval by (e.g., of) the operator for masking removal. The controller 230 removes the masking from the object that performed the corresponding act by determining that a criminal act or a suspected criminal act has occurred in the surveillance video, so that an operator may observe the video in real time or later review stored video to identify the person object.

Referring again to FIGS. 3 to 8, when the object recognition model of the AI processing circuitry 250 recognizes a vehicle object in the surveillance video, the controller 230 applies basic privacy masking to a partial area of the vehicle object, such as an area in which a vehicle license plate is located and an area in which a driver is located, so that the partial area cannot be identified (S150). The vehicle object means a transportation means for movement, such as a motorbike or an automobile.

However, when the situation determination model of the AI processing circuitry 250 determines that the person object from which masking has been removed in S140 has entered or boarded the vehicle object, the controller 230 removes the privacy masking applied to the vehicle object (S160).

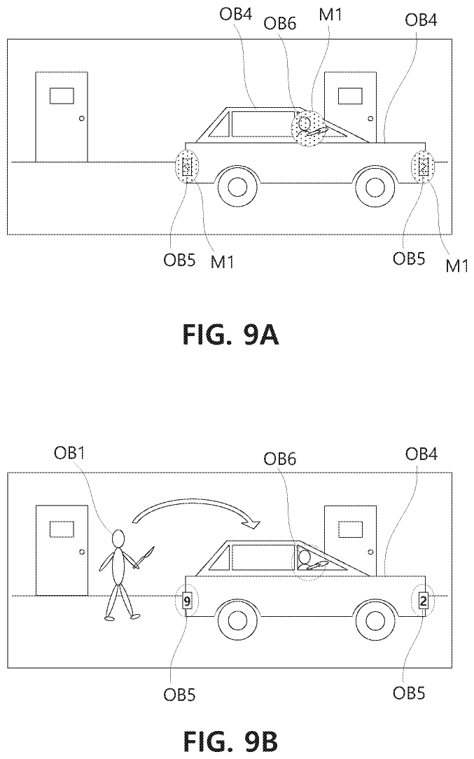

FIGS. 9A and 9B illustrate a masking application method when a person object from which masking has been removed enters or boards a vehicle object.

FIG. 9A illustrates a state in which basic privacy masking M1 is applied to a vehicle license plate area OB5, a driver area OB6, and the like of a vehicle object OB4 recognized in surveillance video, so that the corresponding areas cannot be identified. FIG. 9B illustrates a state in which, when the person object OB1 from which masking has been removed performs an action associated with the vehicle object OB4 to which privacy masking has been applied, for example, when it is detected that the person object OB1 enters or boards the vehicle object OB4, the masking applied to the vehicle object OB4 is removed. Here, the controller 230 may remove masking from an area preset by the operator according to an option selected by the operator, such as a vehicle license plate, a vehicle window, or the entire vehicle, among masked objects. When the operator option is set to automatic setting, the controller 230 may automatically determine and remove a masking area according to a type of object associated with the person object OB1. For example, when the person object OB1 enters or boards the vehicle, a masking removal area may be determined according to the identified vehicle, such as a driver seat portion, a license plate portion, or an entire area of the vehicle.

Meanwhile, object re-identification (Re-ID) technology may be applied in this process. The object re-identification technology refers to a technology for identifying an object in cases where, when an object previously identified in one scene exits the scene and later reappears, the video management device identifies the object as the same object; when an object previously identified in one scene is occluded by another object in the scene and is lost from tracking, and later reappears, the video management device identifies the object as the same object; or when a specific object passes through surveillance areas of a plurality of surveillance cameras, the video management device identifies and tracks the object passing through the surveillance areas as the same object in video of the surveillance areas. In this case, the video management device may store vector data representing features of an object identified in video captured by each surveillance camera in metadata of the identified object. Then, when a new object enters from outside a scene, when an object occluded by another object appears, or when a new object appears in a surveillance area of neighboring surveillance cameras, the video management device may compare feature vector data of the detected object with vector data stored in metadata of the disappeared object, and may identify the detected object as the same object when the feature vector data is identical to, or has a degree of matching equal to or greater than a predetermined value with, the stored vector data. Accordingly, when an object previously identified in one scene exits the scene and later reappears, when an object previously identified in one scene is occluded by another object and later reappears, or when a specific object passes through surveillance areas of a plurality of surveillance cameras, the detected object may be re-identified as the same object. In the present disclosure, identity of feature vector data of an object is used as a criterion for identifying the same object, but various other methods may also be used.

In the case of detecting that the person object OB1 enters or boards the vehicle object OB4, vector data representing features of the person object OB1 holding the predetermined object OB3 may be calculated, stored in metadata of the person object OB1, and used to assign an object identifier. When the person object OB1 passes through a plurality of surveillance areas, vector data representing features of an object detected in surveillance video for each surveillance area may be calculated and compared with the vector data stored in the metadata of the person object OB1. An object for which identity is recognized may be assigned the same object identifier as the person object OB1, thereby tracking movement of the person object OB1 to the vehicle object OB4. Thereafter, when the person object OB1 overlaps the vehicle object OB4 and disappears from a scene, or is re-identified in a partial area of the vehicle object OB4 in the scene, it may be determined that the person object OB1 has entered or boarded the vehicle object OB4. Through this process, the controller 230 may determine whether the person object OB1 has entered or boarded the vehicle object OB4. When it is determined that the person object OB1 has entered or boarded the vehicle object OB4, the controller 230 may remove the privacy masking applied to the vehicle object OB4, so that an operator or law enforcement personnel can confirm identification information of the vehicle object OB4, thereby tracking a means of escape of the person object OB1 suspected of being a criminal.

Meanwhile, when the masking applied to the person object is removed in the surveillance video, the controller 230 may generate an alarm notifying that a masking removal event has occurred. The alarm may be generated as sound or may be visually displayed on a monitor of the operator.

Video data to which masking has been applied or video data from which masking has been removed according to the above-described method may be stored in the above-described video storage 300 of FIG. 1, and the video may then be reviewed according to a predetermined procedure.

In the above description, steps, processes, or operations may be further divided into additional steps, processes, or operations, or may be combined into fewer steps, processes, or operations, according to implementations of the present disclosure. In addition, some steps, processes, or operations may be omitted as necessary, and the order of steps or operations may be changed. In addition, each step or operation included in the above-described selective masking method for surveillance video may be implemented as a computer program and stored in a computer-readable recording medium, and each step, process, or operation may be executed by a computer device.

Hereinafter, an apparatus for performing the above-described selective masking method for surveillance video will be described.

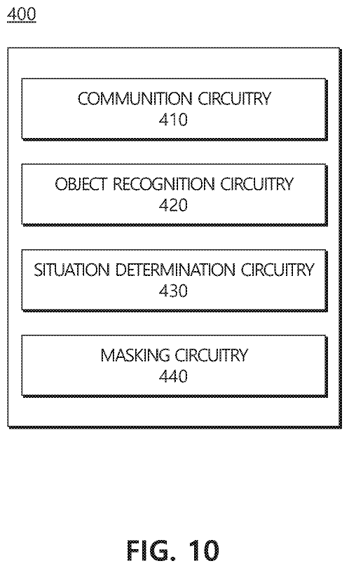

FIG. 10 is a diagram illustrating, as functional blocks, a configuration of a selective masking apparatus for surveillance video according to an embodiment.

Referring to FIG. 10, the selective masking apparatus 400 for surveillance video may include communication circuitry 410, object recognition circuitry 420, situation determination circuitry 430, and masking circuitry 440. The illustrated components are not essential, and a selective masking apparatus for surveillance video having more or fewer components may be implemented. These components may be implemented as hardware, software, or a combination of hardware and software.

The communication circuitry 410 may receive surveillance video obtained by a surveillance camera capturing a surveillance area.

The object recognition circuitry 420 may analyze the surveillance video received through the communication circuitry 410 using an artificial intelligence-based object recognition model, and may recognize objects such as a person, a firearm, a sharp or edged weapon, and a blunt weapon in the surveillance video.

The situation determination circuitry 430 may analyze the surveillance video received through the communication circuitry 410 using an artificial intelligence-based situation determination model, determine an action of a person object in the surveillance video, and detect or classify a sound occurring in the surveillance video.

The masking circuitry 440 may apply masking to an object recognized by the object recognition circuitry 420 according to a masking criterion.

Specifically, when the object recognition circuitry 420 recognizes a person object in the surveillance video, the masking circuitry 440 may mask the recognized person object in a de-identified state. The masking in the de-identified state may refer to privacy masking, and may mean masking sufficient to protect personal information and privacy of the object.

Meanwhile, when the object recognition circuitry 420 detects a predetermined object from the person object masked in the de-identified state, the masking circuitry 440 may change the masking applied to the person object masked in the de-identified state to an “identification state”. Here, the “identification state” may mean a masking state in which the privacy masking is released/removed, but at least one of a color, intensity, shape, region, range, or size of the masking is changed so that an observer can easily identify or recognize the person object. The predetermined object may include a firearm, a sharp or edged weapon, a blunt weapon, or the like.

Meanwhile, when the situation determination circuitry 430 detects an event associated with the predetermined object in the surveillance video, the masking circuitry 440 may remove the masking from the person object masked in the identification state. Here, occurrence of the event associated with the predetermined object may mean occurrence of a sound and/or an action associated with the predetermined object. The sound and/or action associated with the predetermined object may include an action determined to indicate that a criminal act has been committed by the person object and a sound caused by or associated with the action. The sound associated with the predetermined object may include a gunfire sound or a scream of a person. The action associated with the predetermined object may include an action of holding or firing a firearm, an action of stabbing with or swinging a sharp or edged weapon, and an action of swinging a blunt weapon.

Specifically, when the object recognition circuitry 420 detects a blunt weapon or a sharp or edged weapon among the predetermined objects in the surveillance video, and the situation determination circuitry 430 detects, in the surveillance video, that the person object swings the predetermined object or stabs another person object with the predetermined object, the masking circuitry 440 may remove the masking from the person object masked in the identification state.

In addition, when the object recognition circuitry 420 detects a firearm among the predetermined objects in the surveillance video, and the situation determination circuitry 430 detects a screaming sound of a person or a gunfire sound in the surveillance video, the masking circuitry 440 may remove the masking from the person object masked in the identification state.

In addition, when the object recognition circuitry 420 detects, among the predetermined objects, an object located near (e.g., within a threshold distance from) the person object, for example, a chair or a blunt weapon, and the situation determination circuitry 430 detects, in the surveillance video, that the person object performs a harmful action against another person object using the predetermined object, the masking circuitry 440 may remove the masking from the person object masked in the identification state.

Meanwhile, when the object recognition circuitry 420 recognizes a vehicle object in the surveillance video, the masking circuitry 440 may mask at least a portion of the recognized vehicle object, such as an occupant area of the vehicle or a vehicle license plate area, in a de-identified state. However, when the situation determination circuitry 430 determines that the person object from which the masking has been removed has entered or boarded the vehicle object masked in the de-identified state, the masking circuitry 440 may remove the masking from the vehicle portions masked in the de-identified state. Thereafter, video data to which masking has been applied or video data from which masking has been removed may be stored in a separate storage device.

The term “unit” (e.g., a controller, etc.) used in the present specification may mean a component or element including, for example, hardware, software, firmware, or a combination of two or more thereof. The term “unit” may be interchangeably used with terms such as, for example, logic, a logical block, a component, or a circuit. The term “unit” may be the minimum unit of an integrally configured component or a part thereof. The term “unit” may also be a minimum unit configured to perform one or more functions or a part thereof. The term “unit” may be implemented mechanically or electronically. For example, the term “unit” may include at least one of an Application-Specific Integrated Circuit (ASIC) chip, Field-Programmable Gate Arrays (FPGAs), or a programmable logic device, which are known or will be developed in the future and are configured to perform certain operations.

At least a part of a device (e.g., modules or functions thereof) or a method (e.g., operations) according to various embodiments may be implemented as instructions stored in a computer-readable storage medium, for example, in the form of a program module. When the instructions are executed by a processor, the one or more processors may perform functions corresponding to the instructions. The computer-readable medium includes all kinds of recording devices in which data readable by a computer system is stored. The computer-readable storage medium or computer-readable recording medium may include a hard disk, a floppy disk, magnetic media (e.g., magnetic tape), optical media (e.g., compact disc read only memory (CD-ROM) or digital versatile disc (DVD)), magneto-optical media (e.g., a floptical disk), a hardware device (e.g., read only memory (ROM), random access memory (RAM), or flash memory, etc.), and the like. In addition, program instructions may include not only machine code such as that generated by a compiler, but also high-level language code that can be executed by a computer using an interpreter or the like. The above-described hardware device may be configured to execute one or more software modules to perform operations according to various embodiments.

A module or a program module according to various embodiments may include at least one of the above-described components, some of the above-described components may be omitted, or one or more additional components may be further included. Operations performed by a module, a program module, or other components according to various embodiments may be executed in a sequential, parallel, iterative, or heuristic manner. In addition, some operations may be executed in a different order, omitted, or one or more other operations may be added.

The term “a” or “an” as used herein may mean one or more than one. In addition, the use of introductory phrases such as “at least one” and “one or more” in the claims should not be construed to imply that the introduction of another claim element by the indefinite article “a” or “an” limits any particular claim containing such introduced claim element to embodiments containing only one such element, even if the same claim includes the introductory phrases “one or more” or “at least one” and indefinite articles such as “a” or “an.”

As used herein, expressions such as “A or B,” “at least one of A and B,” and “A and/or B” may include A alone, B alone, or both A and B, unless the context clearly indicates otherwise.

Unless otherwise specified, terms such as “first” and “second” are used to arbitrarily distinguish the elements described by such terms. Thus, these terms are not necessarily intended to indicate temporal or other priority of such elements, and the mere fact that certain measures are recited in different claims does not indicate that a combination of these measures cannot be used to advantage.

An arrangement of components to achieve the same function is effectively “associated” such that the desired function is achieved. Hence, any two components combined to achieve a particular functionality can be seen as “associated with” each other such that the desired functionality is achieved, irrespective of structure or intervening components. Likewise, any two components so associated can also be viewed as being “operably connected” or “operably coupled” to each other to achieve the desired functionality.

Furthermore, those skilled in the art will recognize that boundaries between the functionality of the above-described operations are merely illustrative. Multiple operations may be combined into a single operation, a single operation may be distributed into additional operations, and operations may be executed so as to at least partially overlap in time. Moreover, alternative embodiments may include multiple instances of a particular operation, and the order of operations may be altered in various other embodiments. However, other modifications, variations, and alternatives are also possible. The detailed description and drawings are, accordingly, to be regarded in an illustrative rather than a restrictive sense.

As used herein, the term “may” is used to describe optional features or optional embodiments, and does not require that such features be included in every embodiment.

As used herein, the terms “comprising,” “including,” and “having” are used in an open-ended sense and do not exclude additional elements or operations, unless the context clearly indicates otherwise. The terms “consisting of” and “consisting essentially of,” when used, are intended to have their customary meanings in the relevant patent law context.

Those skilled in the art will recognize that boundaries between logic blocks are merely illustrative and that alternative embodiments may merge logic blocks or circuit elements or impose an alternate decomposition of functionality upon various logic blocks or circuit elements. Thus, it is to be understood that the architectures depicted herein are merely illustrative, and that in fact many other architectures can be implemented to achieve the same functionality.

Furthermore, for example, in one embodiment, the illustrated examples may be implemented as circuitry located on a single integrated circuit or within the same device. Alternatively, the examples may be implemented as any number of separate integrated circuits or separate devices interconnected with each other in a suitable manner, and other modifications, variations, and alternatives are also possible. The specification and drawings are, accordingly, to be regarded in an illustrative rather than a restrictive sense.

In addition, for example, the above-described examples or a part thereof may be implemented as software or code representing a logical expression convertible into a physical circuit, or as a physical circuit, such as software or code written in any suitable type of hardware description language.

Furthermore, the present disclosure is not limited to physical devices or units implemented in non-programmable hardware, but can also be applied to programmable devices or units capable of performing desired device functions by operating in accordance with suitable program code, such as mainframes, minicomputers, servers, workstations, personal computers, notebook computers, personal digital assistants (PDAs), electronic games, automotive and other embedded systems, mobile phones, and various other wireless devices, commonly denoted in this application as “computer systems.”

A system, apparatus, or device mentioned in this specification includes at least one hardware component.

Connections as discussed herein may be any type of connection suitable to transfer signals to or from the respective nodes, units, or devices, for example via intermediate devices. Accordingly, unless implied or stated otherwise, the connections may, for example, be direct connections or indirect connections. The connections may be illustrated or described as being a single connection, a plurality of connections, unidirectional connections, or bidirectional connections. However, different embodiments may vary the implementation of the connections. For example, separate unidirectional connections may be used rather than bidirectional connections and vice versa. Also, a plurality of connections may be replaced with a single connection that transfers multiple signals sequentially or in a time multiplexed manner. Likewise, single connections carrying multiple signals may be separated out into various different connections carrying subsets of these signals. Therefore, many options exist for transferring signals.

While embodiments of the present disclosure have been described with reference to the accompanying drawings, the scope of the present disclosure is not limited to the disclosed embodiments. The terms used in the present specification and claims should be interpreted in view of the present specification and the understanding of a person having ordinary skill in the art, unless expressly defined otherwise. Various modifications, changes, and improvements may be made without departing from the scope of the appended claims.

Embodiments disclosed in the present disclosure may be applied to surveillance cameras, surveillance camera systems, and fields of providing services using the same.

What is claimed is:

1. A method performed by an apparatus, the method comprising:
receiving, from a surveillance camera, surveillance feed that captures a surveillance area;
based on a first object being recognized by analyzing the surveillance feed, applying masking, in a first state, to the first object;
based on detecting a predetermined object within the first object, changing the masking applied to the first object from the first state to a second state; and
based on an event associated with the predetermined object being detected in the surveillance feed, removing the masking, in the second state, from the first object.

2. The method of claim 1, wherein the event associated with the predetermined object is an action or a sound associated with the predetermined object.

3. The method of claim 1, wherein the predetermined object comprises a firearm, a sharp weapon, or a blunt weapon.

4. The method of claim 2,
wherein the sound associated with the predetermined object comprises a gunfire sound or a screaming sound, and
wherein the action associated with the predetermined object comprises an action of holding or firing a firearm, an action of stabbing with or swinging a sharp weapon, or an action of swinging a blunt weapon.

5. The method of claim 1, wherein the removing of the masking comprises:
generating, based on the event associated with the predetermined object being detected in the surveillance feed, an alarm notifying that a masking removal target event has occurred.

6. The method of claim 5, wherein the removing of the masking further comprises:
based on receiving approval of a user in response to the alarm, removing the masking from the first object.

7. The method of claim 1, further comprising:
based on a second object being recognized by analyzing the surveillance feed, applying second masking, in the first state, to at least a portion of the second object; and
based on determining that the first object from which the masking has been removed has performed an action associated with the second object, removing the second masking from the at least the portion of the second object.

8. The method of claim 1, wherein the removing of the masking from the first object comprises one of:
based on the predetermined object being a blunt weapon or a sharp weapon and based on detecting, in the surveillance feed, that the first object swings the predetermined object or stabs a second object with the predetermined object, removing the masking from the first object;
based on the predetermined object being a firearm and based on a screaming sound or a gunfire sound being detected in the surveillance feed, removing the masking from the first object; or
based on the predetermined object being located within a threshold distance from the first object and based on detecting, in the surveillance feed, that the first object performs a harmful action against another object using the predetermined object, removing the masking from the first object.

9. An apparatus comprising:
a communication interface configured to receive, from a surveillance camera, surveillance feed that captures a surveillance area;
one or more processors; and
memory storing instructions that are configured to, when executed by the one or more processors, cause the apparatus to:
based on a first object being recognized by analyzing the surveillance feed, apply masking, in a first state, to the first object;
based on detecting a predetermined object within the first object, change the masking applied to the first object from the first state to a second state; and
based on an event associated with the predetermined object being detected in the surveillance feed, remove the masking, in the second state, from the first object.

10. The apparatus of claim 9, wherein the event associated with the predetermined object is an action or a sound associated with the predetermined object.

11. The apparatus of claim 9, wherein the predetermined object comprises a firearm, a sharp weapon, or a blunt weapon.

12. The apparatus of claim 10,
wherein the sound associated with the predetermined object comprises a gunfire sound or a screaming sound, and
wherein the action associated with the predetermined object comprises an action of holding or firing a firearm, an action of stabbing with or swinging a sharp weapon, or an action of swinging a blunt weapon.

13. The apparatus of claim 9, wherein the instructions are configured to, when executed by the one or more processors, cause the apparatus to remove the masking by:
generating, based on the event associated with the predetermined object being detected in the surveillance feed, an alarm notifying that a masking removal target event has occurred; and
based on receiving approval of a user in response to the alarm, removing the masking from the first object.

14. The apparatus of claim 9, wherein the instructions are configured to, when executed by the one or more processors, further cause the apparatus to:
based on a second object being recognized by analyzing the surveillance feed, apply second masking, in the first state, to at least a portion of the second object; and
based on determining that the first object from which the masking has been removed has performed an action associated with the second object, remove the second masking from the at least the portion of the second object.

15. The apparatus of claim 9, wherein the instructions are configured to, when executed by the one or more processors, cause the apparatus to:
based on the predetermined object being a blunt weapon or a sharp weapon and based on detecting, in the surveillance feed, that the first object swings the predetermined object or stabs a second object with the predetermined object, remove the masking from the first object;
based on the predetermined object being a firearm and based on a screaming sound or a gunfire sound being detected in the surveillance feed, remove the masking from the first object; and
based on the predetermined object being located within a threshold distance from the first object and based on detecting, in the surveillance feed, that the first object performs a harmful action against another object using the predetermined object, remove the masking from the first object.

16. A method performed by an apparatus, the method comprising:
receiving, from a surveillance camera, surveillance feed that captures a surveillance area;
based on a plurality of objects being recognized by analyzing the surveillance feed, applying, in the surveillance feed, masking, in a first state, to portions of the plurality of objects and outputting the surveillance feed;
based on a predetermined object being detected within the plurality of objects in the surveillance feed, changing, in the surveillance feed, the masking applied to a first object, among the plurality of objects, within which the predetermined object is detected, from the first state to a second state and outputting the surveillance feed; and
based on an event associated with the predetermined object being detected by analyzing an action of the first object in the surveillance feed, removing, in the surveillance feed, the masking, in the second state, from the first object and outputting the surveillance feed.

17. The method of claim 16, wherein the event associated with the predetermined object is an action or a sound associated with the predetermined object.

18. The method of claim 16, wherein the predetermined object comprises a firearm, a sharp weapon, or a blunt weapon.

19. The method of claim 17,
wherein the sound associated with the predetermined object comprises a gunfire sound or a screaming sound, and
wherein the action associated with the predetermined object comprises an action of holding or firing a firearm, an action of stabbing with or swinging a sharp weapon, or an action of swinging a blunt weapon.

20. The method of claim 16, further comprising:
based on a second object being recognized in the surveillance feed, applying second masking, in the first state, to at least a portion of the second object; and
based on determining that the first object from which the masking has been removed has performed an action associated with the second object, removing the second masking from the at least the portion.
